(19) United States
(12) Patent Application Publication
(10) Pub. No.: US 2015/0098458 A1
(43) Pub. Date: Apr. 9, 2015

(54) WIRELESS LOCAL AREA NETWORK SYSTEM AND WIRELESS NETWORK DETECTION AND SETUP METHOD APPLIED THERETO

(71) Applicant: Sercomm Corporation, Taipei (TW)

(72) Inventors: Yu-Li Shen, Taipei City (TW); Hai-Rong Gu, Jiangsu Province (CN); Bao-Feng Tang, Jiangsu Province (CN)

(21) Appl. No.: 14/306,259

(22) Filed: Jun. 17, 2014

(30) Foreign Application Priority Data
Oct. 9, 2013 (CN) 201310467263.9

(51) Int. Cl. H04W 76/02; H04W 48/18

(52) U.S. Cl. CPC H04W 76/021; H04W 48/18
USPC 370/338

(57) ABSTRACT

A wireless local area network system and a wireless network detection and setup method applied thereto are provided. The system includes a base station and at least one wireless device, wherein a first service set identifier is preset in both of the base station and the at least one wireless device. The method includes following steps: the base station and the at least one wireless device use the first service set identifier to enter a first setup mode; in the first setup mode, the base station is automatically connected to the wireless device via at least one connection path and inspects the at least one connection path; the base station and the at least one wireless device end the first setup mode, stop using the first service set identifier, and switch to use a second service set identifier for connection according to an inspection result.

This application claims the benefit of People's Republic of China application Serial No. 201310467263.9, filed Oct. 9, 2013, the subject matter of which is incorporated herein by reference.

### BACKGROUND

1. Field of the Invention

The disclosure relates in general to a wireless local area network, and more particularly to a system and associated method that simplifies the user's setup procedure related to wireless network connection and wireless security.

2. Related Art

As the mobile computing technology advances and the popularity of wireless network grows, people can connect to a wireless network to transmit data conveniently by a mobile computing device, such as a laptop computer, a cellular phone, a personal digital assistant, a tablet computer, an IP camera, a set-top box, and so on. Concerning the current technology, these mobile computing devices are connected to the Internet via the wireless local area network (WLAN) of the area where they are, or via the third generation (3G) of mobile telecommunications technology.

Most of the current wireless local area network setup methods are time-consuming and inconvenient for the user. Moreover, the user hardly knows the transmission quality between each device and can hardly judge whether to optimize the wireless local area network or not.

### SUMMARY

The disclosure is directed to a wireless local area network system and a wireless network detection and setup method applied thereto. The system and the method applied thereto simplify the user's setup procedure for wireless network connection and security. The connection paths of a wireless device are automatically detected, such that the user can know the transmission quality when completing connection or receive an alert message that the connection cannot be made successfully.

A wireless network and setup method applied to a wireless local area network system is provided. The system includes a base station and at least one wireless device, wherein a first service set identifier is preset in both of the base station and the at least one wireless device. The method includes following steps: the base station and the at least one wireless device use the first service set identifier to enter a first setup mode; in the first setup mode, the base station is automatically connected to the at least one wireless device via at least one connection path and inspects the at least one connection path; the base station and the at least one wireless device end the first setup mode, stop using the first service set identifier, and switch to use a second service set identifier for connection according to an inspection result.

According to another aspect of the invention, a wireless local area network system is provided. The system includes a base station and at least one wireless device. There is at least one connection path between the base station and the at least one wireless device. A first service set identifier is preset in both of the base station and the at least one wireless device, and the base station and the at least one wireless device use the first service set identifier to enter a first setup mode. Wherein in the first setup mode, the base station is automatically connected to the wireless device via the at least one connection path and inspects the at least one connection path, and then the base station and the at least one wireless device end the first setup mode, stop using the first service set identifier, and switch to use a second service set identifier for connection according to an inspection result

According to another aspect of the invention, a wireless network and setup method applied to a remotely controlled network system is provided. The remotely controlled network system includes a wireless local area network and a remote control terminal. The wireless local area network includes a base station and at least one wireless device. The method includes following steps: the remote control terminal sends a detection command to the wireless local area network; the base station is automatically connected to the at least one wireless device via at least one connection path and inspects the at least one connection path; and the base station is connected to the at least one wireless device according to an inspection result, and the wireless local area network system sends the inspection result to the remote control terminal.

According to another aspect of the invention, a remotely controlled network system is provided. The system includes a remote control terminal and a wireless local area network system, which is connected to the remote control terminal via the Internet and configured to receive a detection command from the remote control terminal. The wireless local area network system includes a base station and at least one wireless device, wherein there is at least one connection path between the base station and the at least one wireless device. In response to the detection command, the base station is automatically connected to the at least one wireless device via the at least one connection path and inspects the at least one connection path, then the base station is connected to the at least one wireless device according to an inspection result, and the wireless local area network system sends the inspection result to the remote control terminal.

The invention will become apparent from the following detailed description of the preferred but non-limiting embodiments. The following description is made with reference to the accompanying drawings.

### BRIEF DESCRIPTION OF THE DRAWINGS

FIG. 1 shows a diagram of a wireless local area network system 200 according to a first embodiment of the invention.

FIG. 2A shows a flowchart that only one of the wireless devices is activated or added to the wireless local area network system 200.

FIG. 2B shows a flowchart that another wireless device accompanied by a repeater are activated or added to the wireless local area network system 200.

FIG. 3 shows a diagram of a remotely controlled network system 300 according to a second embodiment of the invention.

FIG. 4 shows a flowchart of the setup procedure in the second embodiment.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The detailed description about the structure and the principle of this disclosure is given below with reference to the accompanying drawings.

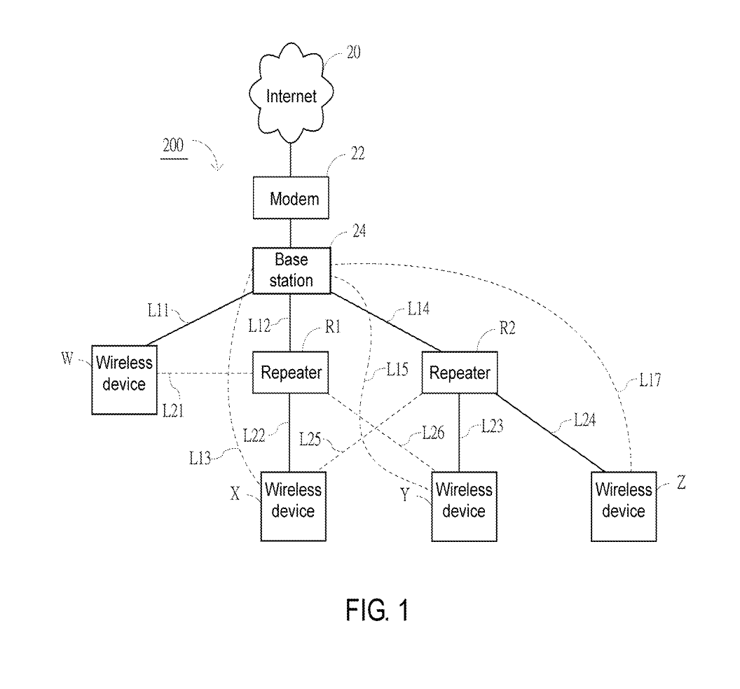

FIG. 1 shows a diagram of a wireless local area network system 200 according to a first embodiment of the invention. As shown in FIG. 1, the wireless local area network system 200 includes a base station 24, a modem 22, multiple repeaters R1, R2 and multiple wireless devices (clients) W, X, Y, Z. The wireless devices W, X, Y, Z can be connected to the Internet 20 via the base station 24 (or the corresponding repeater) and the modem 22. Data may be transmitted wirelessly between the base station 24 (or the corresponding repeater) and the corresponding wireless device.

A wireless network detection and setup method proposed in this disclosure is applied to the wireless local area network system 200. A first service set identifier (SSID 1) may be preset in the base station 24, multiple repeaters R1, R2 and multiple wireless devices W, X, Y, Z in the system 200. SSID 1 may have been preset in those devices while being manufactured, or may be preset by the firmware update procedure afterwards. Of course the wireless local area network system 200 may also include other repeaters and/or wireless devices in which SSID 1 has not been preset.

The technique in this disclosure is somehow similar to establishing another specific SSID 1 on the basis of Wi-Fi Protected Setup (WPS). When the devices in this system can pass the authentication of this identifier, information can be exchanged during the connection process. Therefore, the wireless network detection and setup method proposed in this disclosure is to complete the specific connection inspection and the wireless network connection setup by using the authentication of SSID 1 on the wireless devices W, X, Y, Z and repeaters R1, R2 in the system 200. After completing the wireless network connection setup, the devices in the wireless local area network system 200 may stop using SSID1 and switch to use another service set identifier, such as a second service set identifier (SSID 2), and connect according to the inspection and setup result. For example, SSID 2 may be set by the user or determined by the base station 24, or may be provided by a remote control terminal. When the devices in the wireless local area network system 200 use SSID 2 for connection, the devices may further use a specific encryption key (WPA/WPA2).

As shown in FIG. 1, two repeaters and four wireless devices are illustrated in this embodiment. The architecture of the system 200 is a partially connected mesh topology. In this architecture, the base station 24 has at least one connection path to each wireless device to make all the wireless devices complete connection. In other words, the connection paths of the wireless devices include paths directly connecting the base station 24 to the corresponding wireless device and paths connecting the base station 24 to the corresponding wireless device passing through the corresponding repeater.

The disclosure is characterized in that when setting or activating a wireless device in the system 200, the related connection paths of the wireless device will be inspected and one of the paths will be selected to complete connection and setup to facilitate subsequent wireless data transmission. Meanwhile, a detected connection level is generated according to the inspection result and may be displayed to inform the user.

The inspection of the connection paths in this embodiment utilizes the packets transmitted between the base station 24 and the wireless devices during the inspection process. By calculating the performance, such as packet error rate (PER) or data rate, the transmission rate (including upload rate and download rate) or the transmission throughput on the corresponding connection path can be calculated to reflect the transmission quality and signal strength when completing connection.

Due to the different transmission conditions required by different wireless devices, when each wireless device is added to the system 200, the base station 24 sets a corresponding performance index (PI) for each wireless device in order to apply the wireless network detection and setup method in this disclosure. The performance index may include a minimum level, a good level, and an excellent level. For example, if the wireless device is a set-top box, the minimum transmission rate required for the wireless video signal is about 15 Mbps, and thus the corresponding minimum level of the performance index is 15 Mbps. If the detected connection level of the connection path is greater than the minimum level, the connection can be made according to the generated detected connection level. If the detected result shows an even better transmission condition, a better connection level can be applied for sure.

Moreover, the wireless network detection and setup method proposed in this disclosure may coexist with Wi-Fi Protected Setup (WPS) in the wireless local area network system 200. Different modes can be activated or entered by the user's different operation methods to perform the corresponding setup. In this embodiment, the first operation method corresponds to the first setup mode, which is SSID 1 authentication mode in this disclosure. The second operation method corresponds to the second setup mode, which is WPS mode. For example, each of the base station 24 and the corresponding wireless devices is equipped with a setup button. The activation method for entering different modes may be designed as follows: the first operation method is activated by double clicking the setup button, while the second operation method is activated by single clicking the setup button.

The setup button described above may be a hardware button. In addition to a hardware button equipped physically, of course the setup button may also be a software button, such as an interface displaying different setup modes in a setup window. Alternatively, if the wireless device is a smart phone, a corresponding application program may be installed on the phone, and the first operation method may be activated by activating the corresponding application program. In this embodiment, after the system enters the first setup mode, the SSID 1 authentication between the base station 24 and the corresponding wireless device is activated.

Based on the architecture shown in FIG. 1, there are several setup types: First, only one of the wireless devices is activated or added to the system 200. Second, the system 200 has completed the connection between the base station 24 and any one of the wireless devices, and then another wireless device accompanied by a repeater are activated or added to the system 200. Third, the system 200 has completed the connection between the base station 24 and multiple wireless devices (accompanied by any repeater), and subsequently one to many other wireless devices (may be accompanied by one to many other repeaters) are activated or added to the system 200. The description about these setup types is given below.

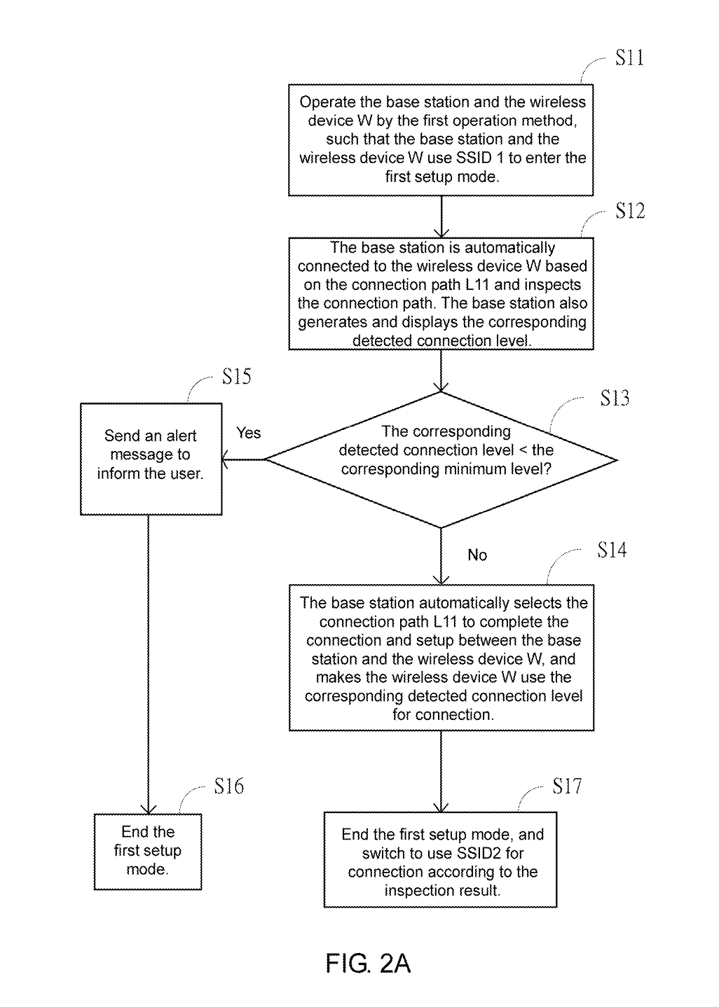

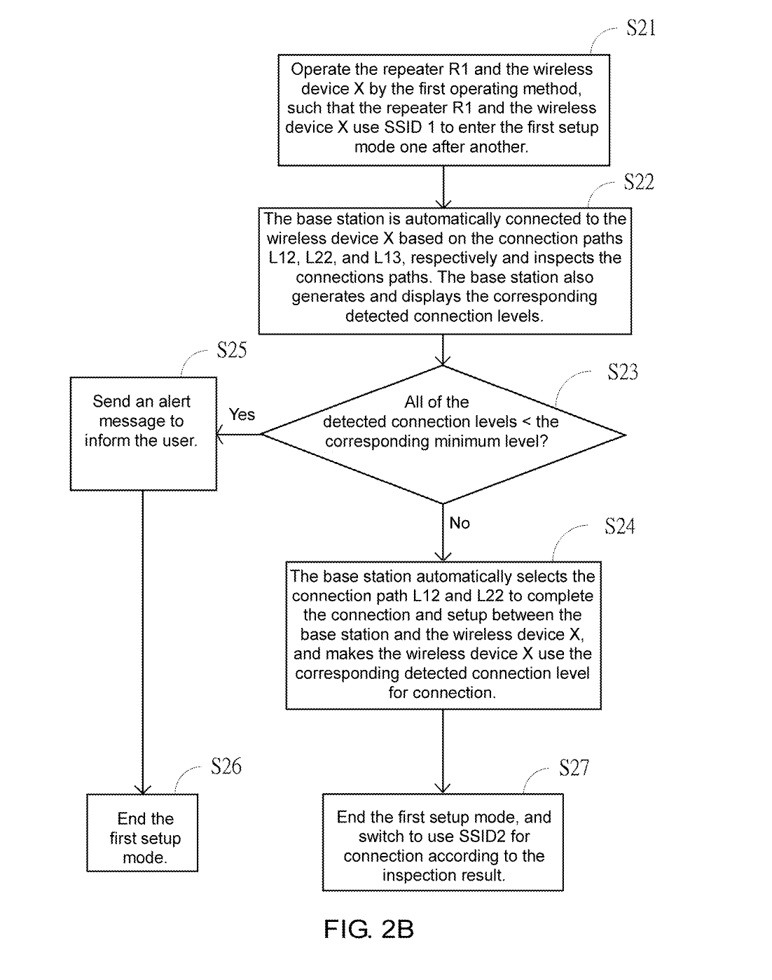

As for the first setup type (only one of the wireless devices is activated or added to the system 200), please refer to the flowchart shown in FIG. 2A. The description is based on only setting the base station 24 and the wireless device W. First, the base station 24 and the wireless device W are operated by the first operation method, such that the base station 24 and the wireless device W use SSID 1 to enter the first setup mode (step S11). In this embodiment, the operating objects of this setup type are similar to those in WPS mode, and hence a corresponding operation is also applied to the base station. In this disclosure, the user first double clicks the setup button of the base station 24, and then double clicks the setup button of the wireless device W to enter the first setup mode. The wireless device W searches the wireless network in the region of the base station 24 that also supports the first setup mode.

Next, in the first setup mode, the base station 24 is automatically connected to the wireless device W based on the connection path L11 and inspects the connection path. The base station also generates and displays the corresponding detected connection level (step S12). In this embodiment, this step is for the inspection of the connection path L11 directly connecting between the base station 24 and the wireless device W. As described above, the inspection may include the calculation about packet transmission so as to obtain the detected connection level corresponding to the connection path L11. In addition, the user may know the detected connection level from a display interface, such as a small screen on the device or a window displayed on the screen.

Then, the base station 24 compares the detected connection level with the corresponding PI. That is, the base station 24 compares the detected connection level (which may be transmission rate or transmission throughput) supported by the current connection path with the minimum level required to be provided to the wireless device W (step S13). If the detected connection level is greater than the corresponding minimum level, it represents that the device can function properly by using the connection path L11 for connection, and hence the base station 24 automatically selects a corresponding connection path. In this embodiment, the base station 24 selects the connection path L11 to complete the connection and setup between the base station 24 and the wireless device W, and makes the wireless device W use the corresponding detected connection level for connection (step S14).

The disclosure is further characterized in that if the detected connection level is less than (or alternatively, less than or equal to, which may be setup differently depending on the situation) the minimum level, in this embodiment it represents that the wireless device W will not function properly by using the only connection path L11 for connection, the base station 24 will send an alert message to inform the user (step S15). For example, the alert message may be setting a corresponding light signal on the device, or showing the corresponding information in a window. In this situation, the user can know the wireless network architecture in the system 200 has to be adjusted by, for example, moving the wireless device W closer to the base station 24, or placing a repeater in the system 200 (such as the repeater R1 shown in FIG. 1). In this way, the wireless device can function properly for wireless connection.

Finally, it may be designed that after a certain amount of time during which the connection and setup of the corresponding wireless device W has been completed, or after the alert message has been sent to inform the user, the base station 24 ends the first setup mode (step S16 or S17), which means the SSID 1 authentication between the base station 24 and the wireless device W is terminated. After that, the base station 24 and the corresponding wireless device W may stop using SSID 1 and switch to use SSID2 for connection according to the inspection and setup result (step S17).

As for the second setup type (the system 200 has completed the connection between the base station 24 and any one of the wireless devices, such as the wireless device W described above, and then another wireless device accompanied by a repeater are activated or added to the system 200), please refer to the flowchart shown in FIG. 2B. The description is based on setting the base station 24, the repeater R1 and the wireless devices W and X. First, the repeater R1 and the wireless device X are operated by the first operating method, such that the repeater R1 and the wireless device X use SSID 1 to enter the first setup mode one after another (step S21).

In this embodiment, because the base station 24 and the wireless device W have completed connection and remain connected, the base station can enter the first setup mode again accordingly based on the step S21. Therefore, the user only has to first double click the setup button of the repeater R1, and then double click the setup button of the wireless device X. In detail, the repeater R1 that enters the first setup mode searches the wireless network in the region of the base station 24 that also supports the first setup mode. After the base station 24 is automatically connected to the repeater R1 based on the connection path L12, the wireless device X enters the first setup mode in order to search the wireless network in the region of the repeater R1 that also supports the first setup mode.

Next, in the first setup mode, the base station 24 is automatically connected to the wireless device X based on the connection paths L12, L22, and L13, respectively and inspects the connection paths. The base station 24 also generates and displays the corresponding detected connection levels (step S22). In this embodiment, during this step not only the direct connection path L13 between the base station 24 and the wireless device X is inspected, but also the connection path L12+L22 that passes through the repeater R1 is inspected. As described above, the inspection may include the calculation about packet transmission so as to obtain the detected connection levels corresponding to the connection paths L12, L22, and L13. In addition, the user may also know the detected connection levels from a display interface.

Then, the base station 24 compares the detected connection levels with the corresponding PI. That is, the base station 24 compares the detected connection levels (which may be transmission rate or transmission throughput) supported by the current connection paths, including the path L12+L22 and the path L13, with the minimum level required to be provided to the wireless device X (step S23). If not all the detected connection levels of the wireless device X are less than (or alternatively, less than or equal to) the corresponding minimum level, it represents that there exists at least one path for connection such that the device will function properly. The base station 24 automatically selects the connection path with the detected connection level greater than the corresponding minimum level. In this embodiment, the connection path with the greatest detected connection level among all candidates is selected. For example, if the detected connection level of the path L13 is smaller, the path L12+L22 with greater detected connection level is selected to complete the connection and setup between the base station 24 and the wireless device X, such that the wireless device X uses the corresponding detected connection level for connection (step S24).

In this embodiment, if all the detected connection levels are less than (or alternatively, less than or equal to) the corresponding minimum level, it represents that the wireless device X will not function properly no matter which path is used for connection. The base station 24 will send an alert message to inform the user (step S25) such that the user can know the wireless network architecture in the system 200 has to be adjusted by, for example, moving the wireless device X closer to the repeater R1, or placing another repeater in the system 200 (such as the repeater R2 shown in FIG. 1) so as to provide a connection path with better transmission quality.

Finally, it may be designed that after a certain amount of time the base station 24 ends the first setup mode (step S26 or S27), which means the SSID 1 authentication between the base station 24, the repeater R1 and the wireless device X is terminated. After that, the base station 24, the repeater R1 and the corresponding wireless device X may stop using SSID 1 and switch to use SSID2 for connection according to the inspection and setup result (step S27).

It should be noted that in the second setup type, due to the addition of the repeater R1, although the wireless device W has completed the connection to the base station 24, the repeater R1 provides another connection path L21 for the wireless device W. That is, the base station 24 may perform inspection on both the direct path L11 and the indirect path L12+L21 and then make a new selection. Therefore, the user may optionally double click the setup button of the wireless device W to restart the setup procedure of the connection path between the wireless device W and the base station 24. The setup procedure is the same as the second setup type as described above.

As for the third setup type, the system 200 has completed the connection between the base station 24 and multiple wireless devices (accompanied by any repeater), and subsequently one to many other wireless devices (may be accompanied by one to many other repeaters) are activated or added to the system 200. The third setup type is an implementation of a modified combination of the setup procedures of the aforementioned two setup types. The description is given below based on the base station 24, the repeaters R1 and R2, and the wireless devices W, X, Y, Z shown in FIG. 1. While performing the automatic detection and setup between the base station 24 and the wireless device W (or the wireless device X), or after that connection has been completed, the user also completes the detection, connection and setup between the repeater R2 and the wireless device Y, Z by the same operation method.

Similarly, the wireless device Y may select a direct path L15 or an indirect path L14+L23 for connection. The wireless device Z may select a direct path L17 or an indirect path L14+L24 for connection. On the other hand, the wireless device X that has completed connection may set the connection path again in response to the addition of the repeater R2. For example, the indirect connection path L14+L25 may be selected. Additionally, the wireless device Y that has completed connection may also choose between the repeaters R1 and R2. For example, the indirect connection path L12+L26 may be selected.

Furthermore, in this embodiment, the wireless network architecture of the system 200 may have to be rearranged due to the variation of locations of the wireless devices (the locations of the repeaters do not change). When all the wireless devices W, X, Y, Z have completed connection, the user only has to double click the setup button of the corresponding wireless device or activate the related application program, rather than setting the base station 24 and the repeaters R1, R2 again.

The wireless device in the first embodiment may be a laptop computer, a tablet computer, a set-top box, and so on. The architecture of the wireless local area network is configured to support the wireless signal transmission in the Wi-Fi standard. Based on the concept in this disclosure, the architecture is not restricted to Wi-Fi standard, but may also be the third generation (3G) of mobile telecommunication technology. In addition, the wireless device may be a smart phone. In general, a smart phone is usually connected to the Internet via the 3G mobile communication system in an outdoor environment. While being at home, if the user wishes to know the current transmission rate or wishes to connect the smart phone to the Internet with a higher transmission rate, the smart phone can be applied in the wireless local area network system proposed in this disclosure. The method is to construct this wireless local area network system at home and install an application program including the setup interface related to the connection setup on the smart phone.

As can be known from the above description about the three setup types of the first embodiment, because the devices pass the specific SSID 1 authentication of this disclosure, the devices in the system 200 can perform connection detection by exchanging information, such as transmission rate or transmission throughput. In detail, SSID 1 may be a hidden SSID (the base station uses SSID 1 but does not broadcast SSID 1) and may be used to support Mesh-lite protocol, such that all related devices under this protocol can be connected in the initial setup phase and the paths between these devices can be inspected.

In the first embodiment, if the detected connection level of a newly added device or a rebooted device is greater than the minimum level of PI, the connection is made according to the generated detected connection level. In reality, if more devices are added to the system and operate simultaneously, the transmission quality of the wireless device that has already completed connection may be affected. In other words, the detected connection level during the inspection process represents only the supported transmission rate or transmission throughput at a particular time instant or during a particular time interval. In other implementations, the system may record the variation of transmission rate related to the corresponding device in a time log, which can further be used to generate the corresponding detected connection level.

In addition, the wireless device may also be an IP camera. Generally speaking, an IP camera for monitoring is usually operated by a remote operator via the Internet. Therefore, the first embodiment may be modified such that the entire system may be operated remotely. Similar wireless network detection and setup method is applied thereto to achieve the required performance for wireless network connection. The related design is described below.

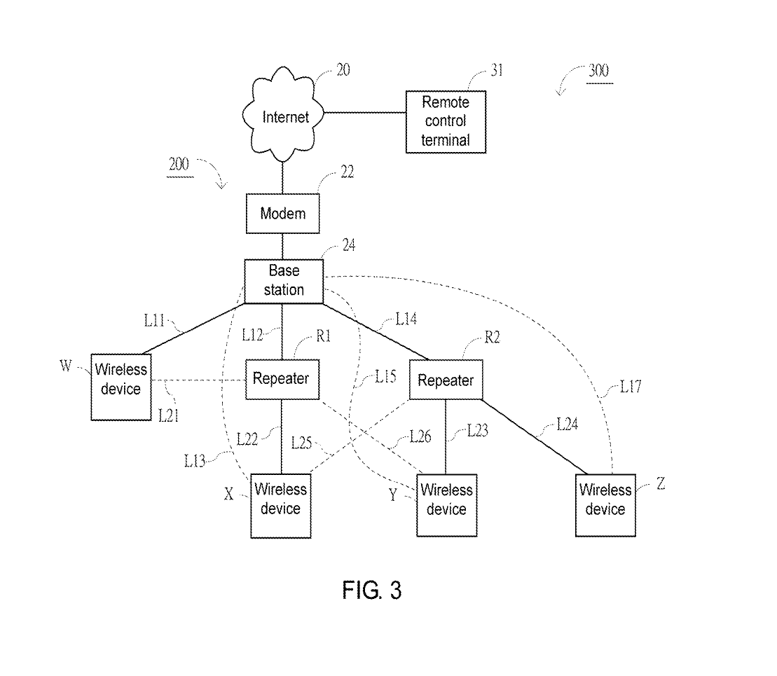

FIG. 3 shows a diagram of a remotely controlled network system 300 according to a second embodiment of the invention. As shown in FIG. 3, the remotely controlled network system 300 includes a wireless local area network system 200 and a remote control terminal 31. The wireless local area network system 200 may be the same as that in the first embodiment, which includes a base station 24, a modem 22, multiple repeaters and multiple wireless devices (clients). A wireless network detection and setup method proposed in this disclosure is applied to the remotely controlled network system 300. Being different from the first embodiment, the wireless local area network system 200 in the second embodiment is connected to the remote control terminal 31 via the Internet 20, and the detection and connection setup is initiated by the remote control terminal 31 instead of by the user's operation on the wireless devices.

In the second embodiment, inspection of connection paths is performed by the technique disclosed in the first embodiment, including setting a corresponding performance index (PI) for each wireless device and selecting a better path to complete the connection setup of the corresponding wireless device. The wireless device in the second embodiment is for example an IP camera and the remote control terminal 31 is for example an auto configuration server (ACS). Although the detected connection level is generated when performing detection on the corresponding wireless device, the system will not display the result to the user since the detection is not initiated by the user's operation in this embodiment. The alert message occurs only when the corresponding wireless device does not function properly.

The setup type of the second embodiment is shown as the architecture in FIG. 3, including a connection between the base station 24 and a corresponding wireless device that does not require a repeater and a connection between the base station 24 and a corresponding wireless device that requires a repeater. The second embodiment is further characterized in that each of the wireless devices W, X, Y, Z has completed connection to the base station 24 (may be via the repeater R1, R2) in the initial state.

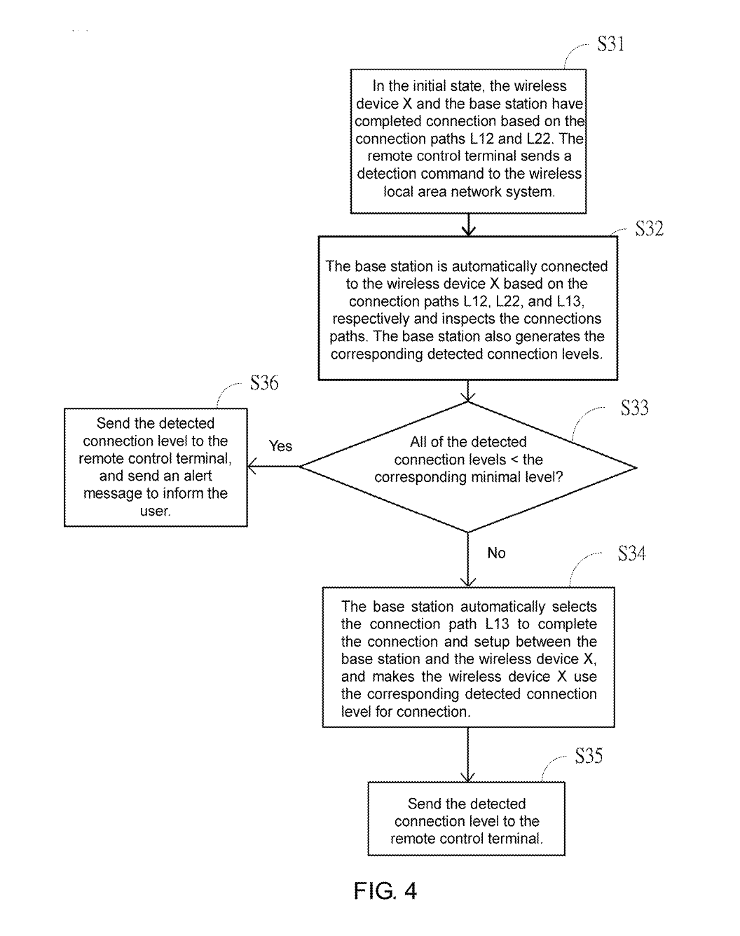

FIG. 4 shows a flowchart of the setup procedure in the second embodiment. The description is based on the base station 24, the repeater R1 and the wireless device X shown in FIG. 3 (not considering the transmission effect of the repeater R2). First, in the initial state, the wireless device X and the base station 24 have completed connection based on the connection paths L12 and L22. The remote control terminal 31 sends a detection command to the wireless local area network system 200 (step S31). The detection command targets the base station 24, the repeater R1 and the wireless device X. Next, the base station 24 is automatically connected to the wireless device X based on the connection paths L12, L22, and L13, respectively and inspects the connections paths. The base station also generates the corresponding detected connection levels (step S32).

In this embodiment, during this step, not only the direct connection path L13 between the base station 24 and the wireless device X is inspected, but also the connection path L12+L22 that passes through the repeater R1 is inspected. Thus, the detected connection levels corresponding to the connection paths L12, L22, and L13 can be obtained. In detail, after sending the detection command, the connection path L12+L22 that has been established may be inspected first to obtain the corresponding detected connection level, and subsequently the wireless device X and the base station 24 may be connected via the direct connection path L13 to perform the inspection on the path L13 in order to obtain the corresponding detected connection level. Alternatively, in other implementations, in the initial state the connection may be made based on the connection path L13.

Then, the base station 24 compares the detected connection levels with the corresponding PI (step S33). If not all the detected connection levels of the wireless device X are less than (or alternatively, less than or equal to) the corresponding minimum level, there exists at least one path for connection such that the device will function properly. The base station 24 automatically selects the connection path with the detected connection level greater than the corresponding minimum level. Similarly, the connection path with the greatest detected connection level among all candidates is selected. For example, if the detected connection level of the path L12+L22 is smaller, the path L13 with greater detected connection level is selected to complete the connection and setup between the base station 24 and the wireless device X, such that the wireless device X uses the corresponding detected connection level (the inspection result) for connection (step S34). Finally, the wireless local area network system 200 sends the detected connection level to the remote control terminal 31 (step S35).

In this embodiment, if all the detected connection levels are less than (or alternatively, less than or equal to) the corresponding minimum level, it represents that the wireless device X will not function properly no matter which path is used for connection. The wireless local area network system 200 still sends the detected connection level to the remote control terminal 31, and the remote control terminal 31 further sends an alert message to inform the user (step S36) that the wireless network architecture in the system 200 has to be adjusted. The adjustment may be for example moving the wireless device X closer to the repeater R1 or the base station 24.

The remote control terminal 31 of this disclosure is connected to the wireless local area network system 200 via the Internet 20. That is, the setup of the remotely controlled network system 300 spans over the Internet 20 for connection and operation. Because the Internet 20 is a public network, while the remotely controlled network system 300 is relatively a private network, the data or packet transmitted would be at risk of being intercepted if not encrypted appropriately. Therefore, the remote control terminal 31 may be connected to the wireless local area network 200 by a point-to-point method of a virtual private network (VPN) to pass through the Internet 20 as if the data is transmitted on a private connection path.

In summary, as disclosed in the first embodiment, when a user adds a wireless device to the system or reboots the wireless device in the system, the user does not have to repeat the same operation method every time. That is, the user does not have to set the base station or the corresponding repeater every time. According to the technique proposed in this disclosure, under the specific SSID 1 authentication, when the wireless device has completed connection to the base station (or accompanied by the repeater), the user only has to perform the specific operation on the wireless device that is newly added or rebooted. Moreover, the user can know the transmission quality when the connection has been completed according to the method proposed in this disclosure.

In addition, as disclosed in the first and second embodiments, when the wireless device performs the connection setup but the related connection path fails to provide the corresponding support, the system sends a message to the user so that the user may adjust the architecture of the wireless local area network. Specifically, the first and the second embodiments disclose that the detection or connection setup is initiated or activated by the user and by the remote control terminal respectively, such that various types of mobile computing device or wireless device can perform the function of wireless connection effectively according to the concept disclosed in the invention. Therefore, the invention overcomes the problem encountered in the prior art and further contributes to the technological progress.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A wireless network and setup method applied to a wireless local area network system, the system comprising a base station and at least one wireless device, wherein a first service set identifier is preset in both of the base station and the at least one wireless device, the method comprising:
the base station and the at least one wireless device using the first service set identifier to enter a first setup mode;
in the first setup mode, the base station being automatically connected to the at least one wireless device via at least one connection path and inspecting the at least one connection path; and
the base station and the at least one wireless device ending the first setup mode, stopping using the first service set identifier, and switching to use a second service set identifier for connection according to an inspection result.

2. The wireless network and setup method according to claim 1, wherein in the first setup mode, the base station being automatically connected to the at least one wireless device via the at least one connection path and inspecting the at least one connection path to generate a corresponding detected connection level, and the method further comprises:
comparing the corresponding detected connection level with a corresponding performance index; and
automatically selecting a corresponding connection path to complete the connection and setup between the base station and the at least one wireless device when the corresponding detected connection level is greater than a minimum level of the corresponding performance index.

3. The wireless network and setup method according to claim 2, further comprising:
the at least one wireless device using the corresponding detected connection level for connection; and
sending an alert message when each of the detected connection level of the at least one wireless device is less than the minimum level of the corresponding performance index.

4. The wireless network and setup method according to claim 1, wherein the system further comprises at least one repeater, the first service set identifier is preset in the at least one repeater, and the method comprises:
the at least one repeater using the first service set identifier to enter the first setup mode.

5. A wireless local area network system, comprising:
a base station; and
at least one wireless device, wherein there is at least one connection path between the base station and the wireless device, a first service set identifier is preset in both of the base station and the at least one wireless device, and the base station and the at least one wireless device use the first service set identifier to enter a first setup mode;
wherein in the first setup mode, the base station is automatically connected to the at least one wireless device via the at least one connection path and inspects the at least one connection path, and then the base station and the at least one wireless device end the first setup mode, stop using the first service set identifier, and switch to use a second service set identifier for connection according to an inspection result.

6. The wireless local area network system according to claim 5, wherein in the first setup mode, the base station is automatically connected to the at least one wireless device via the at least one connection path and inspects the at least one connection path to generate a corresponding detected connection level, further compares the corresponding detected connection level with a corresponding performance index, and automatically selects a corresponding connection path to complete the connection and setup between the base station and the at least one wireless device when the corresponding detected connection level is greater than a minimum level of the corresponding performance index.

7. The wireless local area network system according to claim 6, wherein the base station makes the at least one wireless device use the corresponding detected connection level for connection, and sends an alert message when each of the detected connection level of the at least one wireless device is less than the minimum level of the corresponding performance index.

8. The wireless local area network system according to claim 5, the system further comprising at least one repeater, wherein the first service set identifier is preset in the at least one repeater, and the at least one repeater uses the first service set identifier to enter the first setup mode.

9. The wireless local area network system according to claim 8, wherein the at least one connection path comprises a path directly connecting the base station to the at least one wireless device and a path connecting the base station to the at least one wireless device through the at least one repeater.

10. A wireless network and setup method applied to a remotely controlled network system, the remotely controlled network system comprising a wireless local area network and a remote control terminal, the wireless local area network comprising a base station and at least one wireless device, the method comprising:
the remote control terminal sending a detection command to the wireless local area network;
the base station being automatically connected to the at least one wireless device via at least one connection path and inspecting the at least one connection path; and
the base station being connected to the at least one wireless device according to an inspection result, and the wireless local area network system sending the inspection result to the remote control terminal.

11. The wireless network and setup method according to claim 10, wherein. the base station is automatically connected to the at least one wireless device via the at least one connection path and inspects the at least one connection path to generate a corresponding detected connection level, and the method further comprises:
comparing the corresponding detected connection level with a corresponding performance index; and
automatically selecting a corresponding connection path to complete the connection and setup between the base station and the at least one wireless device when the corresponding detected connection level is greater than a minimum level of the corresponding performance index.

12. The wireless network and setup method according to claim 11, the method further comprising:
the at least one wireless device using the corresponding detected connection level for connection; and
sending an alert message when each of the detected connection level of the at least one wireless device is less than the minimum level of the performance index.

13. The wireless network and setup method according to claim 10, wherein the wireless local area network system further comprises at least one repeater, and the at least one connection path comprises a path directly connected from the base station to the at least one wireless device and a path connecting the base station to the at least one wireless device through the at least one repeater.

14. A remotely controlled network system, comprising:
a remote control terminal; and
a wireless local area network system, connected to the remote control terminal via the Internet, configured to receive a detection command from the remote control terminal, the wireless local area network system comprising:
a base station; and
at least one wireless device, wherein there is at least one connection path between the base station and the at least one wireless device;
wherein in response to the detection command, the base station is automatically connected to the at least one wireless device via the at least one connection path and inspects the at least one connection path, then the base station is connected to the at least one wireless device according to an inspection result, and the wireless local area network system sends the inspection result to the remote control terminal.

15. The remotely controlled network system according to claim 14, wherein the base station is automatically connected to the at least one wireless device via the at least one connection path and inspects the at least one connection path to generate a corresponding detected connection level, further compares the corresponding detected connection level with a corresponding performance index, and automatically selects a corresponding connection path to complete the connection and setup between the base station and the at least one wireless device when the corresponding detected connection level is greater than a minimum level of the corresponding performance index.

16. The remotely controlled network system according to claim 15, wherein the base station makes the at least one wireless device use the corresponding detected connection level for connection, and sends an alert message when each of the detected connection level of the at least one wireless device is less than the minimum level of the performance index.

17. The remotely controlled network system according to claim 14, the wireless local area network system further comprising at least one repeater, wherein the at least one connection path comprises a path directly connecting the base station to the at least one wireless device and a path connecting the base station to the at least one wireless device through the at least one repeater.
